(19) United States
(12) Patent Application Publication
(10) Pub. No.: US 2003/0142069 A1
(43) Pub. Date: Jul. 31, 2003

(54) Hand-held ergonomic computer interface device

(76) Inventors: Frank P. Gatto JR., Reston, VA (US); Alicia M. Hitcho, Reston, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/350,891

(22) Filed: Jan. 24, 2003

Related U.S. Application Data
(60) Provisional application No. 60/352,037, filed on Jan. 25, 2002.

(51) Int. Cl. G09G 5/00

(52) U.S. Cl. 345/156

(57) ABSTRACT

An ergonomic, hand-held computer interface device for computer control. The device transmits control information upon activation of buttons and movement of a rotatable ball on the device. The device which operates without the need for a horizontal surface, within a reasonable distance from the computer and which is shaped to minimize muscle fatigue during longer periods of use. The device offers precision control by means of tension during drawing, controlling and other input requiring precise movement.

### CROSS REFERENCE TO RELATED APPLICATION

This application claims priority under 35 U.S.C. § 119(e) from provisional application No. 60/352,037, filed Jan. 25, 2002. The application is incorporated by reference herein, in its entirety, for all purposes.

### FIELD OF INVENTION

The present invention relates generally to a hand-held computer interface devices, such as those used for altering the display of a computer. More specifically, the present invention relates to a computer mouse that operates without the need of a horizontal surface. A pointing device according to the present invention provides an ergonomically improved computer interface experience, and is shaped to minimize hand, arm, and shoulder muscle fatigue during a long period of continuous use. It also offers precision control pointing during drawing and other input that calls for precise movement.

### BACKGROUND OF THE INVENTION

A number of computer interface devices for entering data into a computer, for controlling the position of the cursor in a computer display, and for precise control over input and design in computer controlled games, animation, and game design programs are known in the art. By way of example, a hand-operated position indicator for a computer controlled display system has been proposed that has a hemispherical housing provided with a plurality of buttons and a sphere located on a bottom structure supported on an underlying surface. The position of the sphere upon movement of the indicator device generates signals indicative of the position of the device and the buttons permit the user to generate signals at appropriate positions for controlling a cathode ray tube (CRT) display. For additional details, refer to U.S. Pat. No. 3,835,464 to Rider, owned by Xerox Corporation.

In more recent years the use of such a controller, now commonly called a “mouse,” for generating signals input to a computer has become very common. In particular, the mouse has become the single most widely accepted keyboard alternative interface device.

A device dubbed the electromechanical “grandfather” mouse was developed at Stanford Research Institute. This mouse employs a pair of wheels that turn potentiometer shafts to encode X and Y motion into analog signals. Further development led to the employment of a ball or sphere instead of two wheels for more uniform tracking. For additional details, refer to the disclosure of U.S. Pat. No. 3,541,541.

The shapes of these devices have changed somewhat since the Rider patent issued in 1974 with many shapes becoming available. However, the basic function remains substantially the same. Specifically, there is typically a housing, which is movable over a flat surface adjacent, a computer display. The bottom of the housing is enclosed by a planar member, which has some form of sensor such as a mechanical sphere or an infrared imaging device to automatically keep track of the position of the controller. One or more buttons are normally provided to permit the user to activate the controller at selected positions relative to a reference point. Typically, there are one or more wires interconnecting the controller to the computer. However, it is also possible to transmit position, date and activation signals by other, wireless means such as infrared transmission.

The fundamental operating principle of the mouse relates to the rotation of a spherical trackball carried within the mouse. When the mouse is moved over a flat surface, the trackball, which is partially exposed, freely rotates within the device and uses transducers to generate signals that correspond to pairs of X-axis and Y-axis coordinates. The mouse contains circuitry to translate these coordinate indicative signals into signals that are readable by the attached computer. Accordingly, when the computer user moves the mouse device across a working surface adjacent to the computer, the cursor indicator on the display screen moves to the location painted to by the computer user. Also, the computer user's operation of one or more buttons aboard the mouse affects other control functions of the computer and computer display, such as the selection of computer usage event options.

One limitation of many of the conventional pointing devices is that the degree of precision control available is crude compared to the power and precision of the data processing devices themselves and detection of fine movements of the interface devices is not well resolved.

Another disadvantage of such a mouse-type hand controller is that its shape is not ergonomically compatible with the user's hand. Consequently, after a long period of use (e.g., several hours), it is not unusual for the muscles to become fatigued, making it uncomfortable and even painful to continue using such a controller without first resting the muscles of the hand, arm and shoulders. Furthermore, the surfaces these hand controllers are used on are usually not designed to permit comfortable support and the palm of the hand, which typically must remain fully extended on a relatively flat surface. This contributes to fatigue of the hand.

There have been some proposals to provide pointing devices with engineered hand engaging surfaces. However, these proposals do not provided for a fully ergonomic surface design or are simply incompatible with the surface shapes needed in a hand controller as opposed to other hand related applications. Also, none of these proposals provides a way for the computer user to alter the shape of the device to fit to the users hand, while at the same time allowing the user to hold the mouse anywhere without the need for a flat surface and within a reasonable distance from the computer.

One proposal conforms more closely than other devices to the operator's motor skills, being operated by hand and finger movements, including both fine movement control and gross movement control. For details of this device, refer to U.S. Pat. No. 4,719,455. The accompanying movement of the screen cursor is not particularly precise. While the mouse's precision is sufficient for most practical purposes, it is not very well suited for graphics and free-hand drawing.

Another proposal is directed to a cordless graphic input device for use with a computer system. The graphic input device includes a cylindrical housing with an overlaying cap member. The cap member is hemi-spherically formed so as to be easily and comfortably cupped within the hand of the use. However, the graphic input device does not have a rotating head or a suitable shape and contour for ergonomic operation. A remote infrared light source transmits user input commands to a detector device adjacent to the computer. The device must operate within a dedicated horizontal, two-dimensional, smooth, flat surface. The detector apparatus operates according to continuous tracking input principles and does not allow for any straying out of equipment detection boundaries. For additional details, refer to U.S. Pat. No. 4,550,250 to Mueller et al.

Another device uses both infrared and ultrasonic principles for determining the direction and the velocity of motion of a positioning device that is monitored by a control base detector. The device requires a two-dimensional plane. To operate from a three-dimensionally defined location, the user must ensure that emitter/detector front face of the positioning device is always directly facing the control base. The device provides no particular ergonomic comfort. For additional details, refer to U.S. Pat. No. 4,578,674.

What is needed is a computer interface device that is configured to provide ergonomically supporting surfaces for the entire muscle structure of a user's hand, while providing precision pointing ability. This would make it possible to avoid or at least substantially reduce muscle fatigue after a long period of use, in particular in the tedious varieties of computer work that rely on precise pointing actions.

### BRIEF SUMMARY OF THE INVENTION

It is therefore an object of the present invention to provide a computer interface device of the type used for generating computer input signal and cursor movement, the device being ergonomically shaped to minimize hand, arm, and shoulder muscle fatigue even during a long period of continuous use.

One aspect of the present invention is that it provides for precision control of the cursor across all radiuses available on the computer.

Another aspect of the present invention is that it does not require a horizontal surface to operate, thus allowing the operator to maintain a comfortable position at all times during use.

It is an additional object of the present invention to provide a computer interface device that is conveniently held in the hand for selectively activating sensors, generating signals for effecting operation of the computer to which the device is electrically or wirelessly connected.

Another object of the present invention is to provide an ergonomically shaped and ergonomically operable device to serve the comfort needs of users.

Accordingly, the present invention offers many distinct and unique advantages, to serve a wide range of user needs. The present invention simplifies access to computers, accelerates interaction between the user and the computer, and provides a device for precise, detailed pointing movement control and input.

Another object of the invention is to provide a computer interface device which is operable from any location reasonably close to the computer being controlled, and which does not require a prominent, dedicated, cleared, smooth, flat horizontal surface or other special surface upon which to operate.

Briefly described, these and other objects of the invention are accomplished with an apparatus that provides an electrically connected or wireless user/computer interface device adapted to communicate with a controllable computer equipped with drive software standards.

An interface device according to a preferred embodiment of the invention has the following characteristics:

provides pointing input sufficiently exact to be used for multi-dimensional operations and for graphical computer work,

allows for rapid and continuous movement of an object or cursor across a computer screen, and for rapid and precise positioning and repositioning of the object,

is well suited for precise and rapid interaction with computers and programs via a graphical interface (menus, icons, etc.),

is suitable for incorporation both in stationary and portable computers, in a way that the same technique can be applied for all types of hardware,

allows for unlimited cursor movement,

allows for rapid execution of commands

provides logical cursor response, i.e. object or cursor responds as intuitively expected in two or three dimensions,

has few movable parts, and

is suitable for modular construction; i.e. allows re-configuration to satisfy different demands.

### BRIEF DESCRIPTION OF THE DRAWINGS

The aforementioned objects and advantages of the invention, as well as additional objects and advantages thereof, will be more fully understood hereinafter as a result of a detailed description of a preferred embodiment when taken in conjunction with the following drawings.

FIG. 1 illustrates a perspective view of a computer interface device according to an embodiment of the present invention.

FIG. 2 illustrates a front elevation view of the computer interface device of FIG. 1.

FIG. 3 illustrates a back elevation view of the computer interface device of FIG. 1.

FIG. 4 illustrates a left elevation view of the computer interface device of FIG. 1.

FIG. 5 illustrates a right elevation view of the computer interface device of FIG. 1.

FIG. 6 illustrates a top plan view of the computer interface device of FIG. 1.

FIG. 7 illustrates a bottom plan view of the computer interface device of FIG. 1.

### DETAILED DESCRIPTION

One embodiment of the present invention is a hand held computer interface device that provides cursor pointing signals and cursor selection signals to a computer. The hand held pointing device has a cylindrical housing, at least one mouse button, and a head ball. The mouse buttons are disposed on the side of the cylindrical housing. Cursor selection signals are produced when a user actuates a mouse button. The head ball is disposed at one end of the cylindrical housing. Cursor pointing signals are produced when a user rotates the head ball.

Another embodiment of the present invention is a hand held computer interface device having a cylindrical housing, at least one mouse button, a head encasement, and a ball. The mouse buttons are disposed on the side of the cylindrical housing. Cursor selection signals are produced when a user actuates a mouse button. The head encasement is disposed at one end of the cylindrical housing and the ball is disposed in the head encasement and free to rotate. Cursor pointing signals are produced when a user rotates the ball.

Still another embodiment of the present invention is a hand held computer interface device that has a cylindrical housing, two or more mouse buttons, a scroll wheel, a head encasement, and a ball. The mouse buttons are disposed on the side of the cylindrical housing. Cursor selection signals are produced when a user actuates a mouse button. The scroll wheel is disposed on the side of the cylindrical housing, adjacent to the mouse buttons. The head encasement is disposed at one end of the cylindrical housing and the ball is disposed in the head encasement and free to rotate. A rotator contact ring is disposed about the head encasement to enable the head encasement to be rotated with respect to the cylindrical housing. The device also has a friction ring. The the ball is nested within the head encasement and is held in place by contact with the friction ring while being free to rotate.

According to any of the various embodiments of the present invention, the cursor pointing signals and cursor selection signals are provided to the computer via a wireless link, or by a hard wire link. A wireless link is effected via propagation of electromagnetic radiation, or via propagation of pressure waves via a fluid medium. For example, acoustic coupling of signals is advantageous in environments where generation of an electromagnetic signature, causing electromagnetic interference (EMI), or receiving EMI is to be avoided.

The exemplary embodiment of the present invention shown in the accompanying figures and described herein is configured for use with the right hand. However, it will be understood that the invention can readily be configured for use with the left hand by simply providing a mirror image version of the right hand configuration. Furthermore, it will be understood that the present invention relates only to the physical configuration of the invention and not to its electrical or computer interface functions, both of which are well known in the art and need not be described herein in detail.

It is well known in the art that many different signal transmission options are available for communicating between computer interface devices and computers. Thus, a variety of wireless and hardwired signal transmission systems are useful for implementing the present invention.

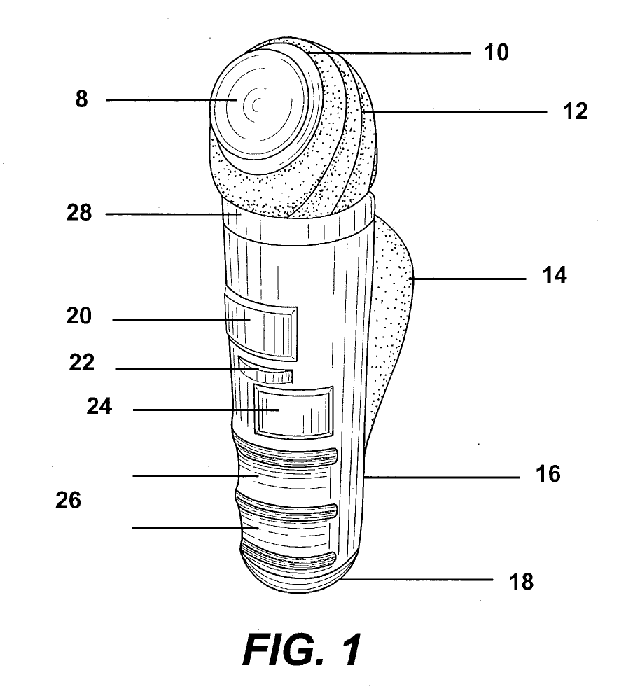

Referring to FIG. 1, a perspective view of a computer interface device according to an embodiment of the present invention is illustrated. This mouse-type pointing device has a hollow cylindrical housing that makes up the body 16 made of (for example, and without limitation) hard plastic. The necessary operational circuitry is disposed inside the body 16.

The device is held in the hand by placing the heel pad 14 against the palm and wrapping the fingers around so that the index finger falls onto the top signal button 20, the middle finger is free or resting on the scroll wheel 22, and the ring finger is on the bottom signal button 24. The remaining pinky finger rests in the finger indents 26 on the bottom front of the body 16. Alternatively, the user who does not desire to use the scroll wheel 22, may grasp the device in their hand so that the index finger is on the top signal button 20, the middle finger is on the bottom signal button 24, and the remaining two fingers (ring and pinky) are rested in the finger indents 26. The thumb is rested on the head ball 8. The internal interface circuitry is housed inside the cylindrical body to convert the user's manipulations of the device into interface signals according to a known signaling technology, for example, PS2 or USB technology. The present invention is adaptable so as to include the implementation of new signaling technologies as they are developed in the future, without departing from the scope of the invention.

Furthermore, the head ball 8 is nested within the head encasement 12 held by the tension of the friction ring 10. The friction ring 10 is adjusted to apply pressure against the head ball 8 at a tension that allows precise movement of the head ball 8. However, the friction ring 10 applies sufficient tension to securely hold the head ball 8 in place and to allow for precise movement of the cursor by the user.

The head encasement 12 rests within the rotator contact ring 28. The rotator contact ring 28 allows the head encasement 12 to be rotated up to 90 degrees left or right, at ten degree increments, starting position being over heel pad 14 enabling the user to rotate the head encasement 12 a total of 180 degrees, at any time so that it is comfortably positioned for the user's thumb when holding as described above. The head encasement 12 rotates over adjoined ribbed contact plates locking at every ten degrees. The head encasement 12 will lock into the position chosen by the user. The head encasement 12 is attached internally and slides over ribbed contacts within to execute commands. However, the cursor is not affected during the rotation of the head encasement 12 within the rotator contact ring 28. The cursor movement is only affected by the head ball 8 manipulations.

Further, once the head encasement 12 is rotated to the comfort of the user, the head encasement 12 locks into the rotator contact ring 28 to hold the position. The rotator contact ring 28 remains static and is attached to the body, but allows the head encasement 12 to rotate as needed.

The top signal button 20 is used to send signals to the users computer using commands corresponding to those of the left button on a conventional mouse. The bottom signal button 24 is used to send signals to the users computer using standard commands corresponding to those of the left button on a conventional mouse. The scroll wheel 22 is used to move the cursor vertically through computer screens using signaling corresponding to that of a scroll wheel on a conventional mouse. Although these items are described in terms of currently standard technology for a conventional computer mouse, it is understood that the function of these items is transformed by being embodied in the present invention, and is thus different from what has gone before; these structures are now free to encompass several additional functions based on the software for which they are used. That is to say, although this device is described by making reference to conventional computer mouse configurations and features, the present invention is not limited to such an implementation.

The heel pad 14, located on the back of the body 16, adjacent to the signal buttons and finger indents 26. The simplest example of a heel pad 14 is one made of soft rubber. Of course, the present invention is not limited to that material. Another example of a heel pad 14 is that it be formed of a hollow rubber bladder filled with gel. The heel pad 14 can easily be removed for cleaning and for replacement of varying sized pads. The heel pad 14 is a supporting surface of the present invention. The heel pad 14 is intended to minimize friction between the user's hand and the body 16 and to maximize comfort while using the device, regardless of the user's hand size.

The closure ring 18 is in place to close the bottom of the body 16 aesthetically, protect the inner circuitry, and permanently attached to the body 16.

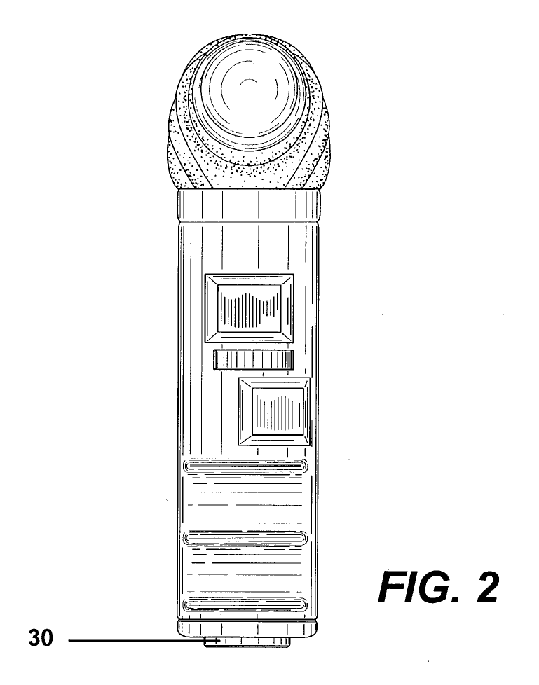

Referring to FIG. 2, a front elevation view of the computer interface device of FIG. 1 is illustrated. The bottom ring 30 allows integration of the hardwire connection of the device to the computer. The wire is preferably connected in a way that allows free rotation of the body 16 without hindering the wire connection or the user.

A cable passage is provided to physically interconnect the device with a computer or other device being controlled thereby. Alternatively, an aperture is provided that is in the appropriate position on the device to permit a wireless control implementation such as infrared transmission.

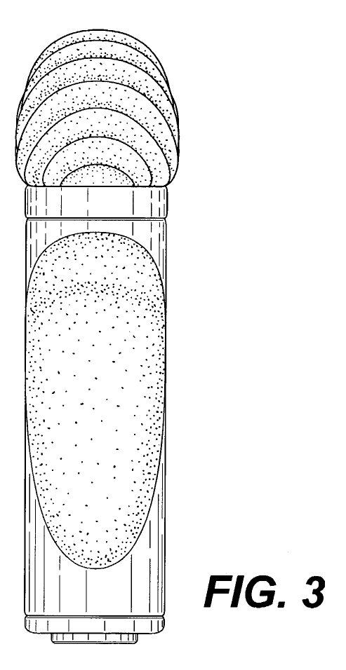

Referring to FIG. 3, a back elevation view of the computer interface device of FIG. 1 is illustrated. The heel pad 14 is shown located on the back of the body 16.

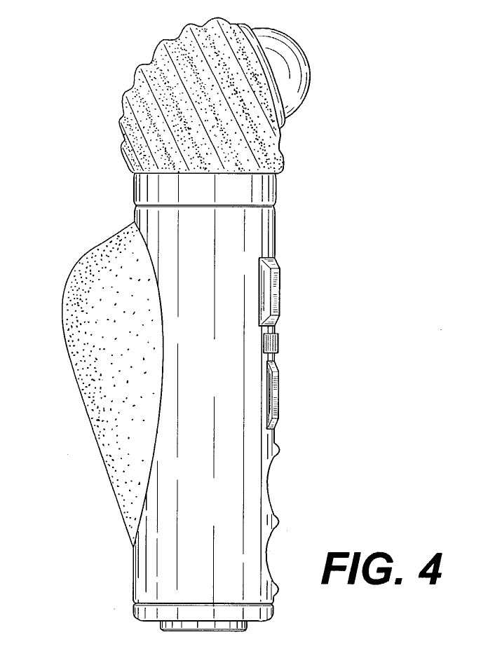

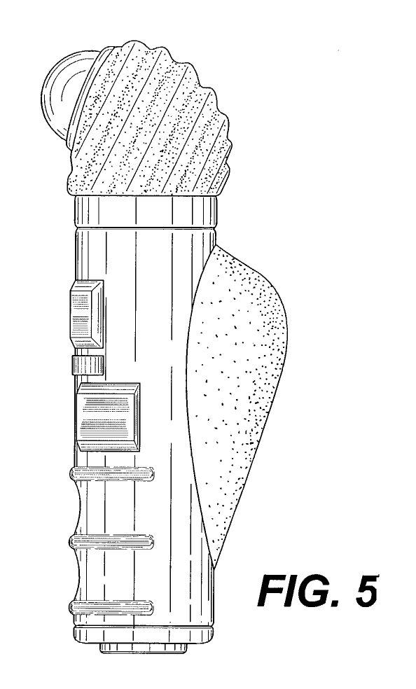

Referring to FIG. 4, a left elevation view of the computer interface device of FIG. 1 is illustrated. A right elevation view of the computer interface device is illustrated by reference to FIG. 5. The heel pad 14 is shown located on the back of the body 16 in opposed relation to the signal buttons 20, 22, 24 and finger indents 26.

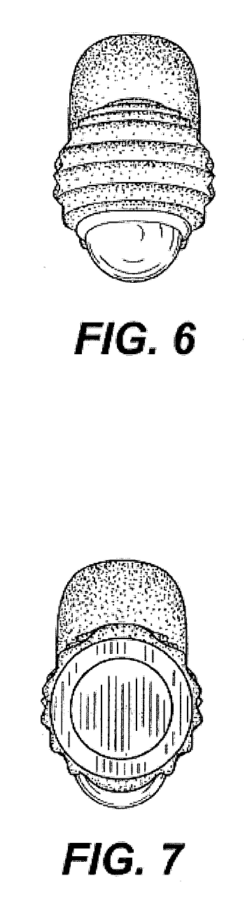

Referring to FIG. 6, a top plan view of the computer interface device of FIG. 1 is illustrated. The ball 8 is nested within the head encasement 12 and is held in place by the tension of the friction ring 10, while being free to rotate. The heel pad 14 is shown projecting from the back of the body 16.

Referring to FIG. 7, a bottom plan view of the computer interface device of FIG. 1 is illustrated. The bottom ring 30 allows integration of a hardwire connection between the device and the computer.

### DESCRIPTION OF OPERATION

The manner of operating the present invention is similar to that for some known computer interface devices described in the background section. Namely, the device is connected to the computer by a wire that sends the commands to the computer's CPU through the PS2 (Personal System 2) or USB (Universal Serial Bus) connection.

Specifically, the user holds the device by wrapping fingers around the body 16, ensuring the heel pad 14 is placed against the palm of the hand in a comfortable manner with the thumb pointing towards the head encasement 12. The fingers fall onto the top signal button 20, the scroll wheel 22, and the bottom signal button 24, allowing for the remaining fingers to fall into the finger indents 26.

The user then adjusts the head encasement 12 by rotating the head encasement 12 within the rotator contact ring 28 to the most comfortable position so that the head ball 8 falls in line with the users thumb. The head encasement 12 will stop at each ten degree around the rotator contact ring 28, however allowing the user to continue if needed. The user may rotate the head encasement 12 a total of 90 degrees either left or right, with a total of 180 degrees available. Once the head encasement 12 and head ball 8 are in the appropriate position, the user will rotate the head ball 8 by moving the thumb in all directions affecting the movement of the cursor on the computer screen. The user will click the top signal button 20, roll the scroll wheel 22 or click the bottom signal button 24 to execute chosen commands on the computer screen.

The user can operate this device from any reasonable distance and any reasonable angle that the wire connection allows. The user may continuously adjust the head encasement 12 to a comfortable position.

It will now be understood that what has been disclosed herein comprises a novel computer interface device for use in generating computer input. It is ergonomically shaped to minimize muscle fatigue even during long periods of continuous use. The various surfaces and shapes of the housing herein described provide a comfortable and natural feeling support surface for virtually all of the anterior surfaces of the hand. In addition, the head of the device will rotate to a comfortable position, and lock into the position chosen. This device provides freedom for the user to move within reasonable distance and angles from the computer, while still being able to control the cursor movement and events.

Those having skill in the art to which the present invention pertains will now, as a result of the applicant's teaching herein, perceive various modifications and additions which may be made to the invention.

For example, the precise shapes shown and described herein may be readily altered in varying degrees while achieving the objects of the invention. Thus for example, the buttons on the front of the device as illustrated currently depress into the body to activate, these may be made pressure sensitive buttons, or heat sensitive buttons to execute commands without substantially reducing the principal advantages of the invention. In addition, several additional buttons can be added to the body to meet software needs, these buttons being of various sizes. Alternatively, the body may be embodied advantageously with only a single button. The scroll wheel shown is common in prior art, however can also be modified by size, or may be eliminated entirely as it is not essential to the practice of the present invention.

The indents shown and referenced can be removed, providing a flat surface on the front of the body, or be continued around the entire surface of the body. The head encasement shown discloses the preferred embodiment with aesthetically pleasing design, however, it is permissible to modify this encasement to a smooth surface without changing the function of the head encasement. The heel pad is shown in the preferred embodiment, but can be modified to different shapes and sizes.

The present invention is described with a hardwired connection to the computer. It is understood that the present invention can be engineered for use with infrared or ultra sonic communication, as well as RF. All figures and parts are referenced with preferred materials for manufacture. Other materials are available and useable without materially affecting the pointing and control function of the present invention. Accordingly, all such modifications and additions are deemed to be within the scope of the invention.

What is claimed is:

1. A hand held computer interface device configured to provide cursor pointing signals and cursor selection signals to a computer, the device comprising:
a cylindrical housing;
a mouse button, disposed on the side of the cylindrical housing, wherein the cursor selection signals are produced in response to actuation of the mouse button; and
a head ball, disposed at one end of the cylindrical housing, wherein the cursor pointing signals are produced in response to movement of the head ball.

2. The hand held device of claim 1, further comprising:
a scroll wheel disposed on the side of the cylindrical housing.

3. The hand held device of claim 1, wherein cursor pointing signals and cursor selection signals are provided to the computer via a wireless link.

4. The hand held device of claim 3, wherein the wireless link utilizes propagation of electromagnetic radiation.

5. The hand held device of claim 3, wherein the wireless link utilizes propagation of pressure waves via a fluid medium.

6. The hand held device of claim 1, wherein cursor pointing signals and cursor selection signals are provided to the computer via a hard wire link.

7. A hand held computer interface device configured to provide cursor pointing signals and cursor selection signals to a computer, the device comprising:
a cylindrical housing;
a mouse button, disposed on the side of the cylindrical housing, wherein the cursor selection signals are produced in response to actuation of the mouse button;
a head encasement disposed at one end of the cylindrical housing; and
a ball, disposed in the head encasement and free to rotate, wherein the cursor pointing signals are produced in response to movement of the ball.

8. The hand held device of claim 7, wherein the head encasement is attached internally to the cylindrical housing and slides over ribbed contacts within the cylindrical housing to produce command signals.

9. The hand held device of claim 7, further comprising:
a rotator contact ring disposed about the head encasement to enable the head encasement to be rotated with respect to the cylindrical housing.

10. The hand held device of claim 7, further comprising:
a friction ring, wherein the ball is nested within the head encasement and is held in place by contact with the friction ring while being free to rotate.

11. The hand held device of claim 7, further comprising:
a heel pad disposed on the side of the cylindrical housing, opposite the mouse button.

12. The hand held device of claim 7, further comprising:
a scroll wheel disposed on the side of the cylindrical housing.

13. The hand held device of claim 7, wherein cursor pointing signals and cursor selection signals are provided to the computer via a wireless link.

14. The hand held device of claim 13, wherein the wireless link utilizes propagation of electromagnetic radiation.

15. The hand held device of claim 13, wherein the wireless link utilizes propagation of pressure waves via a fluid medium.

16. The hand held device of claim 1, wherein cursor pointing signals and cursor selection signals are provided to the computer via a hard wire link.

17. A hand held computer interface device configured to provide cursor pointing signals and cursor selection signals to a computer, the device comprising:
a cylindrical housing;
two or more mouse buttons, disposed on the side of the cylindrical housing, wherein the cursor selection signals are produced in response to actuation of the mouse buttons;
a scroll wheel disposed on the side of the cylindrical housing, adjacent to the mouse buttons;
a head encasement disposed at one end of the cylindrical housing;
a rotator contact ring disposed about the head encasement to enable the head encasement to be rotated with respect to the cylindrical housing;
a ball, disposed in the head encasement and free to rotate, wherein the cursor pointing signals are produced in response to movement of the ball; and
a friction ring, wherein the ball is nested within the head encasement and is held in place by contact with the friction ring while being free to rotate;
wherein cursor pointing signals and cursor selection signals are provided to the computer via a wireless link.
